(19) United States
(12) Patent Application Publication
(10) Pub. No.: US 2002/0075153 A1
(43) Pub. Date: Jun. 20, 2002

(54) Random alarm system

(76) Inventor: Mark V. Dahl, Scottsdale, AZ (US)

Correspondence Address: Michael S. Neustel, Suite No. 4, 2534 South University Drive, Fargo, ND, 58103, US

(21) Appl. No.: 10/046,427

(22) Filed: Oct. 26, 2001

Related U.S. Application Data
(63) Continuation-in-part of application No. 09/593,436, filed on Jun. 14, 2000.

(51) Int. Cl. G08B 23/00

(52) U.S. Cl. 340/573.1; 340/540

(57) ABSTRACT

A random alarm system for facilitating a moment of mindfulness, awareness, stress reduction and quiet at random times during the day. The random alarm system is comprised of an alarm program installed upon a computer system, wherein the alarm program is capable of generating a plurality of random alarm times during a time interval and wherein an alarm is produced from the computer system upon encountering an alarm time. The user may program the alarm program as to the frequency of the random alarms, quiet times, sound level of alarm and various other settings.

### CROSS REFERENCE TO RELATED APPLICATIONS

I hereby claim benefit under Title _{35,} United States Code, Section 120 of U.S. patent application Ser. No. 09/593,436 filed Jun. 14, 2000. This application is a continuation-in-part of the Ser. No. 09/593,436 application. The Ser. No. 09/593,436 application is currently pending. The Ser. No. 09/593,436 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to alarm system and more specifically it relates to a random alarm system for facilitating a moment of mindfulness, awareness, stress reduction and quiet at random times during the day.

Technology has greatly expanded the overall efficiency of today's employees. Arguably one of the greatest technologies invented to assist employee productivity is the modern computer. However, employees that utilize a computer throughout the day typically fail to take the necessary breaks to ensure they are rested and to relax. Extended exposure to a computer monitor can also contribute to various types of vision problems in the work place thereby actually reducing the employee's overall productivity. There is a need for a device that will assist employees and others in randomly becoming aware of a moment in time and to take a needed break.

2. Description of the Prior Art

Alarm clocks and software based reminder systems have been in use for years. Typically, a conventional alarm clock allows the user to program the clock to sound an alarm at a specific time. Software based reminder systems are commonly utilized within calendar software programs such as MICROSOFT OUTLOOK to indicate to a user utilizing a computer an upcoming event date and time. However, neither conventional alarm clocks nor software based reminder systems are designed to randomly sound an alarm for creating a moment of mindfulness, awareness, stress reduction and quite at random times of the day.

Examples of patented clock devices include U.S. Pat. No. 5,051,967 to Dismond; U.S. Pat. No. 4,280,209 to Mooney; U.S. Pat. No. 4,659,231 to Barkouki; U.S. Pat. No. 4,906,982 to Gwynn; U.S. Pat. No. 5,097,429 to Wood et al.; U.S. Pat. No. 4,430,005 to Nishimura; U.S. Pat. No. 4,302,752 to Weitzler; U.S. Pat. No. 4,698,783 to Nishimuro et al.; U.S. Pat. No. 5,706,258 to Poe et al.; U.S. Pat. No. 5,511,046 to Vanderpal; U.S. Pat. No. 5,444,673 to Mathurin; U.S. Pat. No. 4,601,584 to DeWolf et al.; U.S. Pat. No. 4,512,667 to Doulton et al.; U.S. Pat. No. 4,276,541 to Inoue et al. which are all illustrative of such prior art.

While these devices may be suitable for the particular purpose to which they address, they are not as suitable for facilitating a moment of mindfulness, awareness, stress reduction and quiet at random times during the day. Conventional clock devices simply do not randomly notify an individual when it is time to become conscious of a moment in time.

In these respects, the random alarm system according to the present invention substantially departs from the conventional concepts and designs of the prior art, and in so doing provides an apparatus primarily developed for the purpose of facilitating a moment of mindfulness, awareness, stress reduction and quiet at random times during the day.

### SUMMARY OF THE INVENTION

In view of the foregoing disadvantages inherent in the known types of clocks now present in the prior art, the present invention provides a new random alarm system construction wherein the same can be utilized for facilitating a moment of mindfulness, awareness, stress reduction and quiet at random times during the day.

The general purpose of the present invention, which will be described subsequently in greater detail, is to provide a new random alarm system that has many of the advantages of the alarm clocks mentioned heretofore and many novel features that result in a new random alarm system which is not anticipated, rendered obvious, suggested, or even implied by any of the prior art alarm clocks, either alone or in any combination thereof.

To attain this, the present invention generally comprises an alarm program installed upon a computer system, wherein the alarm program is capable of generating a plurality of random alarm times during a time interval and wherein an alarm is produced from the computer system upon encountering an alarm time. The user may program the alarm program as to the frequency of the random alarms, quiet times, sound level of alarm and various other settings.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways such as using software utilized upon a computer, cellular phone, pager and watches. Also, it is to be understood that the phraseology and terminology employed herein are for the purpose of the description and should not be regarded as limiting.

A primary object of the present invention is to provide a random alarm system that will overcome the shortcomings of the prior art devices.

A second object is to provide a random alarm system for facilitating a moment of mindfulness, awareness, stress reduction and quiet at random times during the day.

A further object is to provide a random alarm system for providing a message of merriment for facilitating a moment of stress reduction.

Another object is to provide a random alarm system that allows an individual to record a specific alarm message to be played.

Another object is to provide a random alarm system that assists in the overall reduction of stress within an individual.

A further object is to provide a random alarm system that may be utilized upon various types of computer systems and operating system.

An additional object is to provide a random alarm system that can be utilized by any individual.

A further object is to provide a random alarm system that randomly sounds an alarm.

Another object is to provide a random alarm system that displays a notice upon a computer monitor during an alarm.

Another object is to provide a random alarm system that can be programmed as to the total number of times during an interval that the alarm is activated.

A further object is to provide a random alarm system that can be programmed to have “quiet times” where the alarm is not sounded such as during lunch hours or non-business hours.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an exemplary block diagram of a computer system to be utilized in conjunction with the present invention.

FIG. 2 is a flowchart illustrating the configuration of the present invention.

FIG. 3 is a flowchart illustrating the operation of the present invention.

FIG. 4 is an exemplary dial og box for allowing configuring of the present invention.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

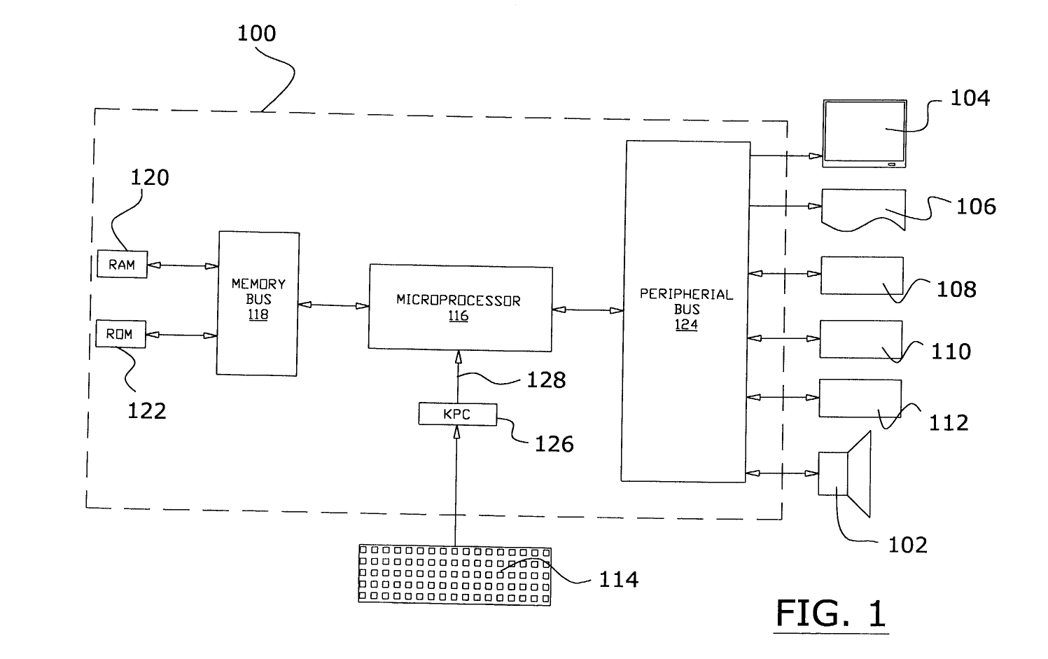

FIG. 1 is a block diagram of an exemplary computer system 100 for practicing the various aspects of the present invention. The computer system 100 includes a display screen (or monitor) 104, a printer 106, a floppy disk drive 108, a hard disk drive 110, a network interface 112, and a keyboard 114. Computer system 100 includes a microprocessor 116, a memory bus 118, random access memory (RAM) 120, read only memory (ROM) 122, a peripheral bus 124, and a keyboard controller 126. Computer system 100 can be a personal computer (such as an APPLE computer, an IBM computer, or one of the compatibles thereof), a workstation computer (such as a SUN MICROSYSTEMS or HEWLETT-PACKARD workstation), or various other types of computers.

The microprocessor 116 is a general-purpose digital processor that controls the operation of the computer system 100. Microprocessor 116 can be a single-chip processor or implemented with multiple components. Using instructions retrieved from memory, microprocessor 116 controls the reception and manipulations of input data and the output and display of data on output devices.

The memory bus 118 is utilized by the microprocessor 116 to access the RAM 120 and the ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output and storage devices used by the computer system 100. In the described embodiment(s), these devices include a display screen 104, a printer device 106, a floppy disk drive 108, a hard disk drive 110, and a network interface 112. A keyboard controller 126 is used to receive input from the keyboard 114 and send decoded symbols for each pressed key to microprocessor 116 over bus 128.

The display screen 104 is an output device that displays images of data provided by the microprocessor 116 via the peripheral bus 124 or provided by other components in the computer system 100. The printer device 106 when operating as a printer provides an image on a sheet of paper or a similar surface. Other output devices such as a plotter, typesetter, etc. can be utilized in place of, or in addition to, the printer device 106.

The floppy disk drive 108 and the hard disk drive 110 can be utilized to store various types of data. The floppy disk drive 108 facilitates transporting such data to other computer systems, and the hard disk drive 110 permits fast access to large amounts of stored data.

The microprocessor 116 together with an operating system operate to execute computer code and produce and use data. The computer code and data may reside on RAM 120, ROM 122, or hard disk drive 120. The computer code and data can also reside on a removable program medium and loaded or installed onto computer system 100 when needed. Removable program mediums include, for example, CD-ROM, PC-CARD, floppy disk and magnetic tape.

The network interface circuit 112 is utilized to send and receive data over a network connected to other computer systems. An interface card or similar device and appropriate software implemented by microprocessor 116 can be utilized to connect the computer system 100 to an existing network and transfer data according to standard protocols.

The keyboard 114 is used by a user to input commands and other instructions to the computer system 100. Other types of user input devices can also be used in conjunction with the present invention. For example, pointing devices such as a computer mouse, a track ball, a stylus, or a tablet to manipulate a pointer on a screen of the computer system 100.

The present invention can also be embodied as computer readable code on a computer readable medium. The computer readable medium is any data storage device that can store data which can be thereafter be read by a computer system. Examples of the computer readable medium include read-only memory, random-access memory, magnetic data storage devices such as diskettes, and optical data storage devices such as CD-ROMs. The computer readable medium can also be distributed over a network coupled computer systems so that the computer readable code is stored and executed in a distributed fashion.

The random alarm system 10 comprises an alarm program installed upon the computer system 100, wherein the alarm program is capable of generating a plurality of random alarm times during a time interval and wherein an alarm is produced from the computer system 100 upon encountering an alarm time. The user may program the alarm program as to the frequency of the random alarms, quiet times, sound level of alarm and various other settings.

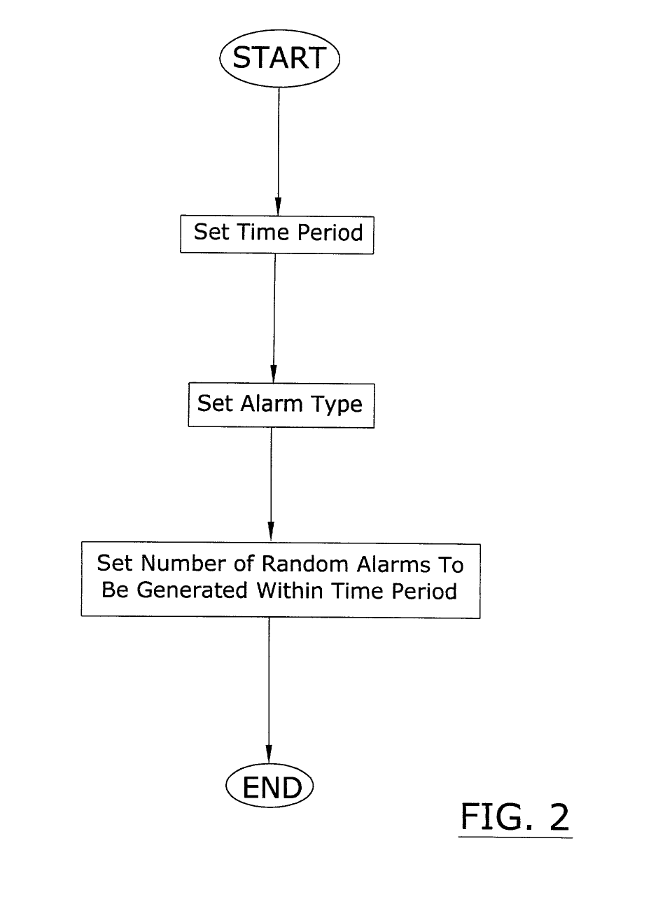

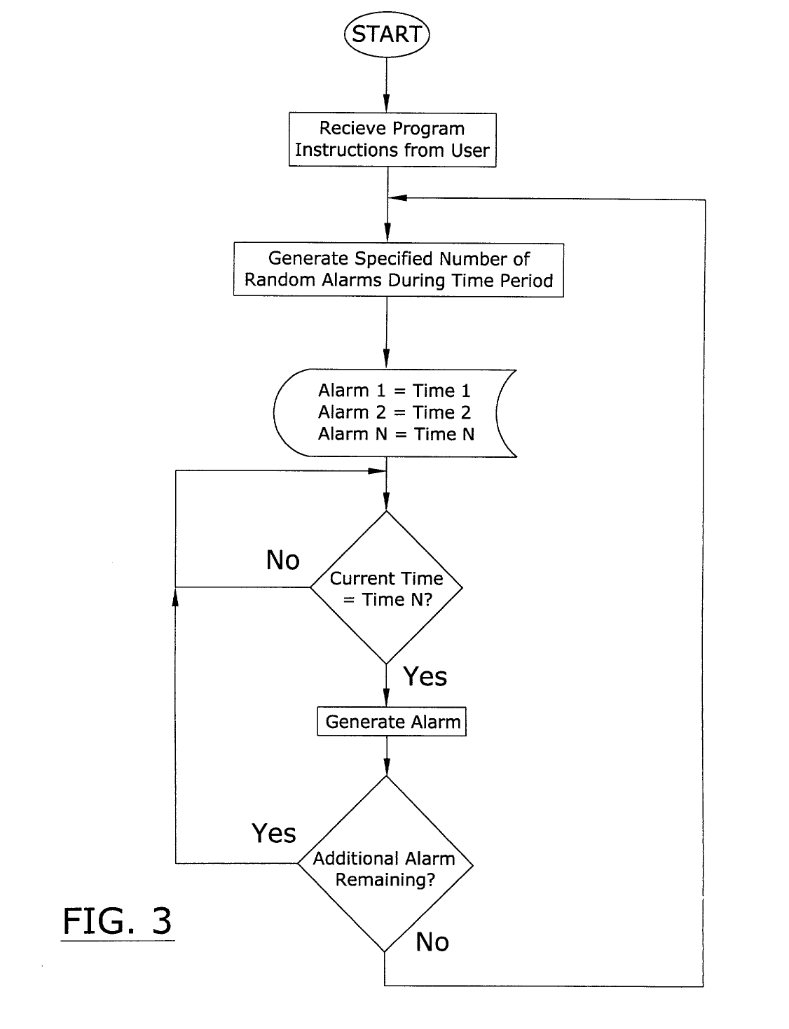

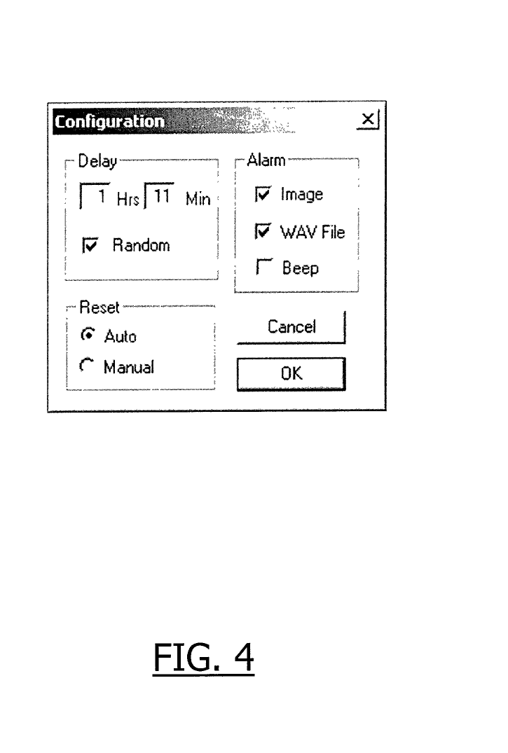

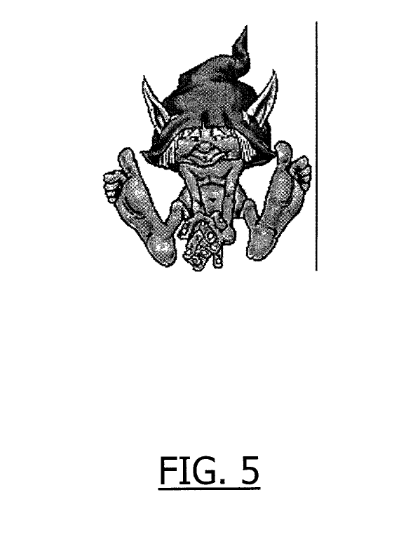

The alarm program preferably operates upon the computer system 100 in the “background” thereby allowing the user to freely utilize the computer system 100 for other tasks. FIGS. 2 and 4 of the drawings illustrate an exemplary system for configuring the present invention according to the user's desired settings. The user may set the specific number of “alarms” that are to be generated during a specified time period ranging from zero to a significant number. It can be appreciated that the user may desire to have zero alarms generated during a specific time period.

For example, the user may set the time period to equally every six hours and during this time period they desire to have four alarms randomly generated. The alarm program generates four random alarms to be generated at four specific times during the stated time period. Another example is that the user may specify time periods based upon the time of day such between 8:00 am to 5:00 pm five alarms are randomly generated, between 5:00 pm to 10:00 pm two alarms are randomly generated, and between 10:00 pm to 8:00 am zero alarms are generated.

The user also has the ability to configure the type of alarm that is generated. For example, the user may utilize an existing sound file contained upon the computer system 100 such as a beeping sound or they may utilize a customized sound file such as but not limited to a recording of a human voice. The user may also configure the alarm program so that no sound is emitted when an alarm time is encountered, but rather only a display image is displayed upon the display screen 104 of the computer system 100 as shown in FIG. 4. The display image may be an existing graphical image or a customized graphical image. The display image may also coincide with the emitting of an audible alarm as selected by the user. The display image preferably is displayed upon the display screen 104 on top of any existing images displayed in order to get the attention of the computer user. The display image may disappear by the user selecting the display image with their computer mouse or similar control device.

In use, the user utilizes the configure menu of the alarm program in order to program the number of times the alarm is to be sounded during a specific time interval. For example, the user may desire for the random alarms to only be sounded three times per hour during time period A, five times per hour during time period B, and zero times per hour (“quite time”) during time period C. It can be appreciated that there can be an unlimited number of time periods that can be programmed into the alarm program as desired by the user. The user may also configure the type of alarm such as sound type and graphical display. The user can also program a conventional alarm time for when they desire to wake up. The conventional alarm time sound emitted by the computer system 100 may be different from the random alarm time sound. When activated, the computer system 100 determines which time period and the corresponding number of random alarms to be executed during this time period. The computer system 100 then randomly selects times to emit the random alarm during this time period which creates an awareness in the user. For additional time periods, such as lunch periods or non-business hours, the user may program the alarm program not to emit any random alarms to reduce disturbing others. When the current time equals the first random alarm time, the desired alarm is generated by the computer system 100. The alarm may automatically terminate after a few seconds or may require the user to manually terminate the alarm. This process continues until all of the alarms for the particular period are generated. The computer system 100 then generates the necessary alarm times for the upcoming time period until the user terminates the alarm program.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### Index of Elements for Random Alarm System

100. Computer System

10l.

102. Speaker

103.

104. Display Screen

106. Printer

107.

108. Floppy Disk Drive

109.

110. Hard disk Drive

111.

112. Network Interface

113.

114. Keyboard

115.

116. Microprocessor

117.

118. Memory Bus

119.

120. RAM

121.

122. ROM

123.

124. Peripheral Bus

125.

126. Keyboard Controller

127.

128. Bus

129.

130.

131.

132.

133.

134.

135.

136.

137.

138.

139.

I claim:

1. A random alarm system, comprising:
a computer system having an accurate current time; and
an alarm program installed upon said computer system, wherein said alarm program is capable of generating a plurality of random alarm times during a time interval and wherein an alarm is produced from said computer system upon encountering an alarm time.

2. The random alarm system of claim 1, wherein said random alarm times are controlled by parameters programmed by a user.

3. The random alarm system of claim 2, wherein said random alarm times are generated a programmed number of times during a time interval.

4. The random alarm system of claim 3, wherein said time interval is an hour.

5. The random alarm system of claim 2, wherein said random alarm times are generated a programmed number of times during a time interval based upon a plurality of time periods.

6. The random alarm system of claim 5, wherein said plurality of time periods includes at least one time period having no random alarm times.

7. The random alarm system of claim 1, wherein said alarm is comprised of a sound file played in an audible manner.

8. The random alarm system of claim 1, wherein said alarm is comprised of a display image displayed upon a display screen of said computer system.

9. The random alarm system of claim 1, wherein said alarm is comprised of a sound file played in an audible manner and a display image displayed upon a display screen of said computer system.

10. The random alarm system of claim 9, wherein said plurality of time periods includes at least one time period having no random alarms.

11. A random alarm system, comprising:
a computer system having an accurate current time and displaying said accurate current time upon a display screen; and
an alarm program installed upon said computer system, wherein said alarm program is capable of generating a plurality of random alarm times during a time interval and wherein an alarm is produced from said computer system upon encountering an alarm time.

12. The random alarm system of claim 11, wherein said random alarms are controlled by parameters programmed by a user.

13. The random alarm system of claim 12, wherein said random alarms are generated a programmed number of times during a time interval.

14. The random alarm system of claim 13, wherein said time interval is an hour.

15. The random alarm system of claim 12, wherein said random alarms are generated a programmed number of times during a time interval based upon a plurality of time periods.

16. The random alarm system of claim 15, wherein said plurality of time periods includes at least one time period having no random alarms.

17. The random alarm system of claim 11, wherein said alarm is comprised of a sound file played in an audible manner and a display image displayed upon a display screen of said computer system.

18. The random alarm system of claim 17, wherein said alarm is comprised of a sound file played in an audible manner.

19. A method of providing a random alarm system, comprising the steps of:
(a) providing a computer system having and displaying an accurate current time;
(b) providing an alarm program installed upon said computer system, wherein said alarm program is capable of generating a plurality of random alarm times and wherein an alarm is produced from said computer system upon encountering an alarm time;
(c) receiving program instructions for at least one time period;
(d) generating a plurality of alarms randomly during at least one time period if random alarms are desired during said at least one time period; and
(e) repeat step (c) until said at least one time period expires and then repeat step (c) for a next time period.

20. The method of providing a random alarm system of claim 19, wherein said at least one time period includes at least one time period having no random alarms.
